(19) United States
(12) Patent Application Publication
(10) Pub. No.: US 2015/0278687 A1
(43) Pub. Date: Oct. 1, 2015

(54) USER DEVICE SIDE PREDICTED PERFORMANCE MEASURE ADJUSTMENTS

(71) Applicants: David W. Sculley, II, Pittsburgh, PA (US); Alan Ramsay Skelley, Sunnyvale, CA (US); Arnar Mar Hrafnkelsson, Los Altos, CA (US)

(72) Inventors: David W. Sculley, II, Pittsburgh, PA (US); Alan Ramsay Skelley, Sunnyvale, CA (US); Arnar Mar Hrafnkelsson, Los Altos, CA (US)

(21) Appl. No.: 13/710,914

(22) Filed: Dec. 11, 2012

(51) Int. Cl. G06N 5/02

(52) U.S. Cl. CPC G06N 5/02

(57) ABSTRACT

Methods, and systems, including computer programs encoded on computer-readable storage mediums, including a method for providing to a user device a rule set specifying adjustments to be made by the user device to predicted performance measures of content items presented by the user device. The method includes receiving a content item request from a user device for content items, the user device being associated with a user device identifier; determining content items responsive to the content item request, each of the content items have a predicted performance measure; identifying a rule set specifying adjustments to be performed by the user device to the predicted performance measures of the determined content items in response to particular user interactions with the determined content items when presented on the user device; and providing the determined content items and the rule set to the user device in response to the content item request.

### BACKGROUND

This specification generally relates to information presentation.

The Internet provides access to a wide variety of resources. For example, video and/or audio files, web pages for particular subjects or particular news articles and other content are accessible over the Internet. Access to these resources presents opportunities for content (e.g., advertisements) to be provided with the resources.

To fulfill these opportunities, in some content item selection processes (e.g., auctions), content items are selected based, at least in part, on their respective predicted performance measures. Such predicted performance measures can include, for example, predicted click-through and conversion rates of the content items. In many cases the predicted click-through and conversion rates are based, at least in part, on the historical click-through and conversion rates of the content items.

### SUMMARY

In general, one aspect of the subject matter described in this specification can be implemented in methods that include receiving a content item request from a user device for content items to be presented on the user device, the user device being associated with a user device identifier. Determining content items responsive to the content item request, where each of the content items has a predicted performance measure. Identifying, based at least in part on the user device identifier and a subject matter of the content item request, a rule set specifying adjustments to be performed by the user device to the predicted performance measures of the determined content items in response to particular user interactions with the determined content items when presented on the user device. Providing the determined content items and the rule set to the user device in response to the content item request.

Other embodiments of this aspect include corresponding systems, apparatus, and computer programs, configured to perform the actions of the methods, encoded on computer storage devices.

These and other embodiments can each optionally include one or more of the following features. The method can include receiving adjusted predicted performance measures for the determined content items from the user device and updating the predicted performance measures of the determined content items based at least in part on the adjusted predicted performance measures. The method can include receiving the adjusted predicted performance measures only in response to user selection of one of the determined content items, and wherein only the adjusted predicted performance measures are received in response to the user selection of the one.

The method can include adjusting costs, based at least in part on the adjusted predicted performance measures, to content sponsors of the determined content items for providing the determined content items to the user device in response to the content item request. The particular user interactions can include at least one of user interactions resulting in cursor movements, font sizing, window sizing, and tabbing. The weight of at least one of the adjustments can vary based on a level of a corresponding user interaction. The level of the corresponding user interaction can be a measure of a duration of the corresponding user interaction. The adjustments can include adjustments to one or more of pricing, layout, display treatments, or selection changes of the determined content items.

The method can include generating the rule set based at least in part on the user device identifier and a subject matter of the content item request. The method can include, in response to providing the rule set, receiving only effectiveness data from the user device indicating an effectiveness of one or more rules from the rule set.

Particular implementations of the subject matter described in this specification can be implemented to realize one or more or none of the following advantages. A user's interaction with content items (e.g., advertisements) or the resource on which the content items are presented (e.g., web page) can be leveraged, for example, by a user device's ability to adjust which content items are presented to the user, the format or layout of the presentation of the content items, the content of the content items or some combination thereof without divulging the user's interactions to a third party device. This preserves the privacy of the user's activities.

The presentation of content items to a user can be adjusted in real time by a user device based on the user's interaction with the content items to enhance the user's experience without the cost and latency associated with communicating the user's interactions to a third party device and waiting for the third party device to determine and return such adjustments. The adjustments can include, for example, replacing less relevant content items presented to the user with more relevant content items based on user interests inferred from the user's interactions.

The details of one or more implementations of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram of an example environment for delivering content.

FIG. 2 is a flow diagram of an example process for providing a rule set to a user device.

FIG. 3 is a flow diagram of an example process for performing actions according to the rule set.

FIG. 4 is a block diagram of a programmable processing system.

Like reference symbols in the various drawings indicate like elements.

### DETAILED DESCRIPTION

This specification generally relates to providing a set of content items (e.g., advertisements) along with a rule set (e.g., script or instructions) to a user device in response to a content item request. The rule set specifies adjustments to be performed by the user device to the predicted performance measures associated with the content items (e.g., pre-determined adjustments to the predicted click-through rates of the content items) in response to particular user interactions with the content items when presented on the user device. If adjustments are made to the predicted performance measures as a result of user interactions with the content items then the user device sends the adjustment(s) back to the content serving system that provided the content items (e.g., so the content serving system can update the predicted performance measures based on the adjustments).

The predicted performance measure adjustments are triggered by user interactions at the user device and made by the user device based on the rule set such that only the adjustments are sent to the content serving system and there is no need to send potentially sensitive user information (e.g., particular user interactions) to the content serving system to determine the adjustments. For example, the rule set can specify that if a user causes a cursor to hover over the top content item (e.g., advertisement) in a list of content items for more than X seconds then the predicted performance measures for content items related to the top content item are increased by ten percent and such information is sent to the content serving system.

In some implementations, the rule set can specify actions other than adjustments to predicted performance measures in response to user interactions. For example, the rule set can specify that if a user does not cause a cursor to hover over any of the content items during a specified time period then the content items should slowly disappear from the page. By way of another example, the rule set can specify that if a user causes a cursor to hover over a particular content item then additional information should be added to the content item (e.g., web page links or special offers).

In some implementations, the rule set can specify that user interactions with one content item cause the display of other content items to change. For example, the rule set can specify that if the user causes a cursor to hover over a particular content item then other, previously non-displayed, content items related to the particular content item can replace the content items that were originally displayed with the particular content item. In some implementations, the content management and delivery system provides rules sets to user devices, as described below.

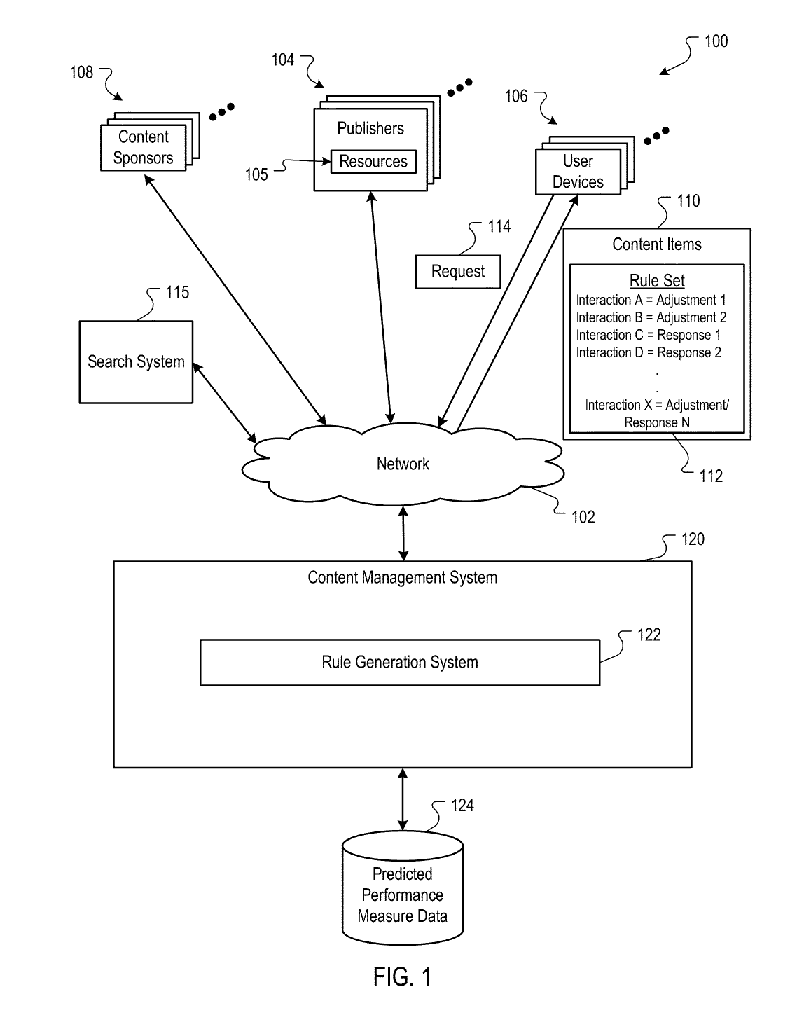

FIG. 1 is a block diagram of an example environment 100 for delivering content. The example environment 100 includes a content management and delivery system 120 for selecting and providing content and rule sets to user devices 106. The example environment 100 also includes a network 102, such as wide area network (WAN), the Internet, or a combination thereof. The network 102 connects publishers 104, user devices 106, content sponsors 108 (e.g., advertisers), a search system 115 and the content management system 120. The example environment 100 may include numerous publishers 104, user devices 106, and content sponsors 108.

A resource 105 can be any data that can be provided over the network 102. A resource 105 can be identified by a resource address (e.g., uniform resource locator, “URL”) that is associated with the resource 105. Resources 105 include HTML pages, word processing documents, portable document format (PDF) documents, images, video, and news feed sources, to name only a few. The resources 105 can include content, such as words, phrases, images, video and sounds, that may include embedded information (such as meta-information hyperlinks) and/or embedded instructions (such as scripts).

In some implementations, the resources 105 can include sponsored content provided by the content sponsors 108 that can be rendered in specific locations (e.g., advertisement slots) in the resource 105. For example, the resources 105 can include an advertisement sponsored by a content sponsor 108.

A user device 106 is an electronic device that is under control of a user and is capable of requesting and receiving resources 105 over the network 102. Example user devices 106 include personal computers, televisions with one or more processors embedded therein or coupled thereto, set top boxes, mobile communication devices (e.g., smartphones), tablet computers, e-readers, laptop computers, personal digital assistants (PDA), and other devices that can send and receive data over the network 102. A user device 106 typically includes one or more user applications, such as a web browser, to facilitate the sending and receiving of data over the network 102 and the rendering of resources 105. The web browser can enable a user to display and interact with text, images, videos, music and other information typically located on a web page on the world wide web or a local area network.

To facilitate searching of these resources 105, a search system 115 can be included in the network 102. The search system 115 can identify resources 105 by, for example, crawling web sites and indexing the resources 105 available from the web sites. The indexed and, optionally, cached copies of the resources 105, can be stored for later use in an indexed data store.

The user devices 106 can submit search queries to the search system 115. The search queries can be submitted in the form of a search request that includes the search query and, optionally, a unique identifier that identifies the user device 106 that submitted the request. The unique identifier can be data from a cookie stored at the user device 106, or a user account identifier if a user causing the submission of the search query maintains an account with the search system 115, or some other identifier that identifies the user device 106 or the user using the user device 106.

In response to the search request, the search system 115 can, for example, use the indexed data store to identify resources 105 that are relevant to the search query. The search system 115 identifies the resources 105 in the form of search results and returns the search results to the user devices 106 in a search results page/resource. A search result is data generated by the search system 115 that identifies a resource 105 that satisfies a particular search query, and includes a resource locator for the resource 105. An example search result can include a resource title, a snippet of text extracted from the resource, and the URL of the resource.

The search results can be ranked based on scores related to the resources 105 identified by the search results, such as information retrieval (“IR”) scores, and optionally a separate ranking of each resource 105 relative to other resources 105. The search results can be ordered according to these scores and provided to the user device 106 according to the order.

The user device 106 receives the search results page(s) and renders the page(s) for presentation to a user. In response to a user selecting a search result at a user device 106, the user device 106 requests the resource 105 identified by the resource locator included in the selected search result. The server hosting the web site from which the resource 105 is available receives the request for the resource 105 from the user device 106 and provides the resource 105 to the requesting user device 106.

The content management system 120 facilitates the provisioning of content items with the resources 105. In particular, the content management system 120 allows content sponsors (e.g., advertisers) to define selection criteria that take into account, for example, attributes of particular users. Example selection criteria include keywords, in which a content sponsor provides bids for keywords that are present, for example, in either search queries or resource content. Content items that are associated with keywords (e.g., having bids that result in a slot being awarded in response to an auction) can be selected for presentation to a user in accordance with these selection criteria.

For situations in which the systems discussed here collect personal information about users, or may make use of personal information, the users may be provided with an opportunity to control whether programs or features collect personal information (e.g., information about a user's social network, social actions or activities, profession, a user's preferences, or a user's current location), or to control whether and/or how to receive content from a contenting providing system that may be more relevant to the user. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server

In addition or alternative to using the selection criteria, the content management system 120 can also base content item selection on predicted performance measures for the content items (e.g., content items with high predicted performance measures are more likely to be selected than those with low predicted performance measures). Such predicted performance measures include, for example, predicted click-through rates and predicted conversion rates. A predicted click-through rate for a content item specifies the predicted likelihood that, when presented by a user device 106 to a user, the content item will be selected (e.g., “clicked on”) by the user. For example, in some implementations, the predicted click-through rate is the ratio (or a function of the ratio) of the number of selections of the content item to the number of impressions (e.g., presentations on a user device 106) of the content item.

A predicted performance measure for a content item can be based on numerous factors and can be situation dependent. For example, the predicted performance measure for a content item can vary based on the content item's display position on a resource 105 (e.g., a content item is more likely to be selected if it is displayed at the top of the resource 105 as opposed to the bottom), the time of day the content item is presented, the geographic location of the user device 106 on which the content item will be presented, the language of the resource 105 on which the content item will be presented, characteristics associated with the user device submitting the content item request (e.g., the relative frequency of content items selections associated with the user device), similarities between the subject matter of the content item and the subject matter of the resource 105 or search query (e.g., semantic similarity between keywords for the content item and keywords from the search query or resource 105) to name a few.

The predicted performance measures can be generated by a predicted performance measure system (not shown) and stored in a predicted performance measure data store 124, and indexed by corresponding content item identifiers. As the predicted performance measures can be dependent on the parameters of a particular content item request, the predicted performance measures can be determined in a content item request receipt time process (e.g., as the content items are selected to satisfy the content item request). In some implementations, the predicted performance measures can be determined in a pre-processing offline process.

The predicted performance measure system can determine a predicted performance measure for a content item based on historical performance data for the content item accessible from content item performance logs. For example, the predicted performance measure system can use the historical performance data with various machine learning techniques, support vector machine techniques or neural networks to determine the predicted performance measures. The content management system 120 can access the predicted performance measures from the predicted performance measure data store 124 (e.g., to include with the rule set 112 as described below).

The content management system 120 can provide content items for many different resources 105, such as the general content resources (e.g., a news web page) and search results page resources. For example, a resource 105 received or accessed by a user device 106 can include instructions (e.g., scripts) that cause the user device 106 to submit a request 114 for one or more content items from the content management system 120. The request can include a publisher identifier and, optionally, keyword identifiers related to the content of the resource 105 or keywords related to a search query (e.g., in the case where the resource 105 is a search page through which the search query has been submitted). The content management system 120, in turn, provides (directly or indirectly) relevant content items to the requesting user device 106, which the user device 106 then displays with the resource 105.

In some implementations, as described below, the content management system 120, in conjunction with providing the requested content items to the user device 106, also provides data specifying a rule set 112 to the user device 106. For example, the content management system 120 can append, embed or otherwise include the data specifying the rule set 112 in or with the HTML of one or more of the requested content items. The rule set 112 can be in the form of instructions such as a script that is executable by the user device's web browser.

In some implementations, the rule set 112 specifies the predicted performance measures of the requested content items that are being delivered responsive to a given request. The rule set 112 can as well specify adjustments to be performed by the user device 106 to these predicted performance measures in response to particular user interactions with the delivered content items (e.g., during the presentation of the content items by the user device 106). For example, the rule set 112 can specify that if a user causes the mouse to hover over a particular content item for three seconds then the user device 106 should increase the predicted performance measure for the particular content item and all related content items (e.g., related in subject matter) by ten percent. Thus the user interaction with one content item can affect the predicted performance measure of other content items.

In some implementations, in addition or alternative to adjusting predicted performance measures, the rule set 112 can include rules that cause the user device 106 to change content items currently displayed, change the layout or format in which the content items are presented or otherwise respond to certain user interactions. For example, the rule set 112 can specify that if the user does not cause the mouse to hover over any content items during the first ten seconds the content items are displayed, and the user continues to not cause the mouse to hover over any content items, then the user device 106 should gradually fade away the presentation of the content items such that after some period of time (e.g., thirty seconds after the initial display) no content items are presented/visible to the user. Alternatively, substitute items can be presented.

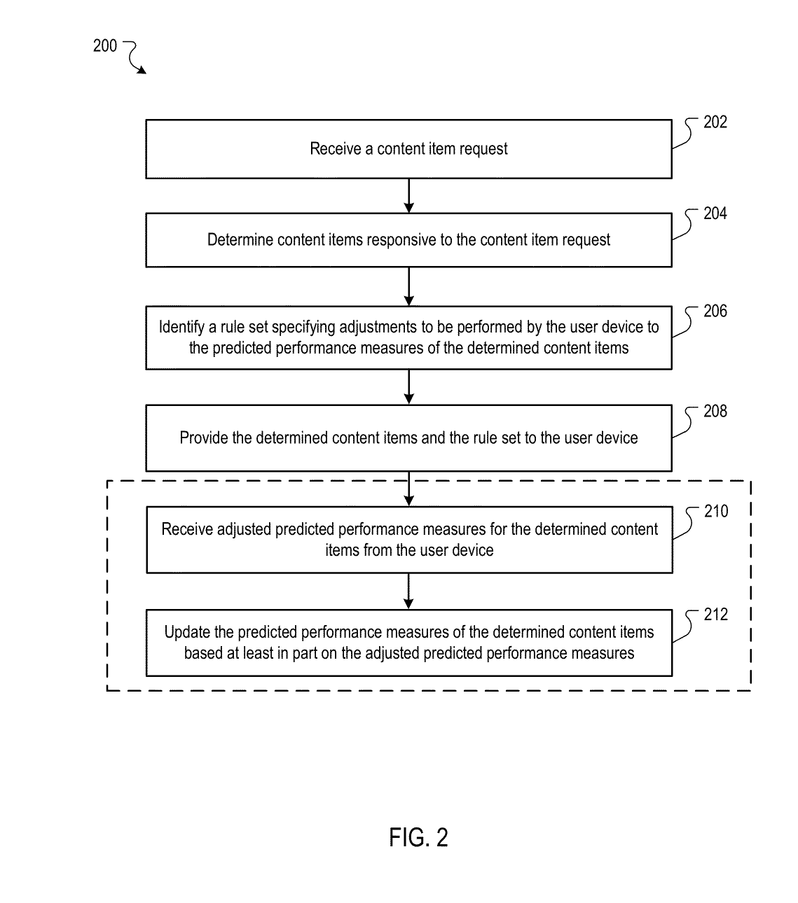

In some implementations, the content management system 120 includes a rule generation system 122 that generates rule sets 112. The operation of the content management system 120 and the rule generation system 122 are described below with reference to FIG. 2.

FIG. 2 is a flow diagram of an example process 200 for providing a rule set to a user device 106. The process 200 can be implemented, for example, by the content management system 120.

A content item request is received from a user device for content items to be presented on the user device (202). In some implementations, the content management system 120 receives a request for content items (e.g., advertisements) from a user device 106 for display on or with a resource 105 being rendered by the user device 106. For example, the resource 105 can be a search results page for a search query and the content item request can be for a set of advertisements related to the search query to display on the right-hand side of the search results page.

In some implementations, the content item request includes a user device identifier associated with the user device 106 that issued the content item request. The user device identifier can be, for example, an anonymized character string based on an IP address of the user device 106, an account identifier of a user of the user device 106 or other identifier associated with the user device 106 (e.g., provided that provision and use of the user device identifier is authorized by the user). As described below, in some implementations, the content management system 120 can use historical browsing data associated with the user device identifier, among other selection criteria, to select relevant content items to satisfy the content item request.

Content items responsive to the content item request are determined (204). In some implementations, the content management system 120, in addition or alternative to the user device identifier, uses content item predicted performance measures as input parameters to a content item selection process (e.g., auction or selection process in a reservation system) responsive to the content item request. In some implementations, the content management system 120, in response to each content item request, conducts a selection process to select content items to provide in response to the content item request.

As described above, a content item can have one or more predicted performance measures. In some implementations, the content items are ranked according to a score that is proportional to a value based on the content item bid and one or more parameters specified in performance information for the content item (e.g., the predicted performance measure). In some implementations, the highest ranked content items resulting from the selection process are selected and provided to the requesting user device 106. In this example, predicted performance measures impact the content item selection process.

A rule set is identified specifying adjustments to be performed by the user device to the predicted performance measures of the determined content items in response to particular user interactions with the determined content items when presented on the user device (206). In some implementations, the rule set is identified based at least in part on the user device identifier and a subject matter of the content item request. A user interaction is an interaction or inaction, caused or directed by a user of a user device 106, between the user and one or more content items or a resource 105 on which content items are displayed. User interactions include, for example, keyboard strokes, mouse (cursor) movements, font sizing or re-sizing, window sizing or resizing, tabbing, content item selections, other resource content selection, other user inputs or engagements with a resource 105 or content item, the absence of a user input or engagement with a resource 105 or content item, or some combination thereof.

User interactions can be detected by the user device 106. In some implementations, the rule set includes instructions (e.g., a script) that cause the user device 106 to detect user interactions by accessing and using one or more application programming interfaces (API) from the browser application operating on the user device 106 and through which the user device 106 renders and displays the resource 105 and the determined content items. For example, such instructions can cause the user device 106 to use browser application APIs to determine mouse cursor positions and movements relative to other content on the resource 105 or to the content items, durations with which the mouse cursor hovers over particular content, selections of content or content items, window resizing (and other changes to the resource 105 and/or content items) to name a few.

In some implementations, a user interaction also has a user interaction level component such as the time duration of the user interaction (e.g., five seconds). Thus the rule set can specify multiple, different responses to the same user interaction based on the level of the user interaction. For example, for user interaction A with a duration of five seconds or less, the rule set specifies that the user device 106 should perform response 1. However, for user interaction A with a duration of more than five seconds, the rule set specifies that the user device 106 should perform response 2 (which is different from response 1).

In some implementations, the rule generation system 122 generates, develops and/or identifies the rule set for the content item request (e.g., to be provided to the requesting user device 106 with the content items responsive to the content item request). The rule generation system 122 generates, develops and/or identifies a rule set for the content item request based on, for example, commonalities among historical user interactions with content items (e.g., the same content items determined in process 204 and/or other content items), commonalities among historical user interactions with the resources 105 on which the content items are presented, historical performance data associated with the user device identifier, demographic data associated with the user device identifier, the time the content item request is received, the geographic location of the user device 106 on which the content items will be presented, the language of the resource 105 on which the content items are to be presented, similarities between the subject matter of the content items and the subject matter of the resource 105 or search query (e.g., semantic similarity between keywords for the content item and keywords from the search query or resource 105), or some combination thereof (collectively, the “rule set generation data”). Thus the rule set can be different for two content item requests (e.g., received at the same time) even if the content items determined to be responsive to the two content item requests are the same, as other factors such as, for example, the geographic location of the requesting user device 106 or associated user device identifier is different.

The rule generation system 122 can generate rule sets by processing the rule set generation data through use of various techniques such as clustering methods, decision tree learning, support vector machine techniques, linear regression techniques and the like. For example, the rule set generation data may specify or indicate that if a mouse is caused to hover over a particular content item (e.g., with subject matter X, as subject matter X is related to the keywords of a search query triggering the content item request) for more than a predetermined amount of time (e.g., three seconds) then there is a high probability (e.g., an eighty percent probability) that one of the currently presented content items will be selected. As such, the rule generation system 122 can generate a rule specifying that the predicted performance measures of all determined content items (e.g., with subject matter related to subject matter X) should be increased by a predetermined amount (e.g., ten percent) in response to a mouse being caused to hover over the particular content item for more than the predetermined amount of time. Thus, in some implementations the rule set can be dependent on the subject matter associated with the content item request.

By way of another example, the rule set generation data may specify or indicate that if a mouse is caused to hover a particular region (e.g., in the top left quadrant) of the displayed resource 105 for more than a predetermined amount of time (e.g., five seconds) then there is a significantly high probability (e.g., ninety-five percent probability) that none of the currently presented content items will be selected. As such, the rule generation system 122 can generate a rule specifying that the predicted performance measures of all currently presented content items on the resource 105 should be decreased by a predetermined amount (e.g., forty percent) in response to a mouse being caused to hover the position of the displayed resource 105 for more than the predetermined amount of time.

In another example, when a user interaction of a user causing a window, in which all of the content items are displayed, to be resized such that some of the content items, after the resizing, are “below the fold,” and hence no longer visible in the window, the rule set can specify that the user device 106 reduce the predicted performance measures of the below the fold content items by a predetermined (e.g., Y) percent (e.g., as the below the fold content items are no longer visible and thus are less likely to be selected).

In some implementations, a rule set can also specify rules based on, for example, the geographic location of the user device 106. For example, the rule set can specify that when a user device 106 is within a certain geographic region (e.g., as determined by the user device's global positioning system), or moving toward a certain geographic region, particular content items relevant to the geographic region be presented. When the user device 106, for example, is determined to be near restaurant X, the rule set specifies that a content item for restaurant X be presented.

Like predicted performance measures, a rule set can be dependent on the parameters associated with a particular content item request. As such, the rule generation system 122 can generate or develop a rule set in a content item request receipt time process (e.g., as the content items are selected to satisfy the content item request). In some implementations, rule sets can, additionally or alternatively, be generated or developed in an offline process. In such cases, the rule generation system 122 can identify a previously generated rule set to provide with the responsive content items based on commonalities between the previously generated rule set and parameters associated with the content item request (e.g., the rule set is based on rule set generation data including performance measure data for content items written in German and the content item request is from a user device 106 located in Germany).

A rule set can specify responses to particular user interactions or resource/user device conditions (e.g., window size) other than (or in addition to) adjustments to predicted performance measures. In some implementations, the rule set can specify, for example, an initial layout or display treatment; or changes or adjustments to the layout, display treatments, or pricing the determined content items. For example, when a user interaction of a user causing a mouse to hover over a particular content item is detected, the rule set can specify that the user device 106 dynamically display additional or different information in the content item (as compared to that which was originally displayed by the content item) such as resource links (e.g., a link to a web page where the user can order the product advertised in the content item) or additional content (e.g., “This product can be purchased at X store near you.”). Such display of additional or different information is referred to as a change in the display treatment of the content item.

As described above, the rule set may specify that certain user interactions with one content item may cause the user device 106 to increase the predicted performance measures of other (e.g., related) content items. This, in turn, may change the rankings of the content items relative to each other as the rankings are based in part on the predicted performance measures of the content items. Given that not all of the content items may be able to be displayed at once, as there are a limited number of display slots and only the highest ranked content items are allotted slots, the change in ranking may cause a content item that was previously not assigned to a slot (because of its low original ranking) to move up in the rankings and displace one of the content items previously assigned to a slot. As such, the rule set can include a rule that instructs the user device 106 to determine the highest ranked content items, after the predicted performance measures have been adjusted in response to the triggering user interaction, and present the updated set of highest ranked content items in the available slots.

The updated set may include content items different from the initially displayed content items and/or the order of the content items in the updated set may be different from the order of the content items as initially displayed. Thus, the rule can cause the user device 106 to change the display layout or configuration of content items in response to a user interaction. As such, a user interaction with a particular content item can result in a response by the user device 106 (e.g., a first action) that causes another, previously un-displayed, content item to be displayed (e.g., concurrently with the particular content item).

By way of another example of a rule set specifying responses to particular user interactions other than (or in addition to) adjustments to predicted performance measures, when a user interaction of a user causing a mouse to hover over a particular content item is detected, the rule set can specify that the user device 106 increase the size of or otherwise expand the particular content item relative to other content on the resource 105. Such a size increase can be, for example, used to present additional information in the content item, as described above.

In still a further example, a content item request for content items for display on a search results page for a search query initially determined to be navigational by the search system 115 (e.g., a search query submitted by a user with the intention of finding a particular resource 105) is received by the content management 120. When a user interaction/inaction of a user not causing a selection of any of the presented content items on the search results page for a specified time period after their initial display is detected, the rule set can specify that the user device 106 request and/or display non-navigation search results on the search results page, e.g., as the initial determination that the search query was navigational may not be correct.

In some implementations, the rule set can include rules to be applied by the user device 106 prior to presenting any content items. For example, the rule set can include rules that specify which of the determined content items, or a display treatment of a particular content item, to initially present based on user preferences/history stored locally at the user device 106, e.g., but not accessible by the content management system 120.

The determined content items and the rule set are provided to the user device in response to the content item request (208). In some implementations, the content management system 120 sends data specifying the content items (e.g., determined at process 204) and the rule set identified for the content item request (e.g., at process 206) to the requesting user device 106. For example, the content management system 120 can append, embed or otherwise include the data specifying the rule set in or with the HTML of one or more of the requested content items.

In some implementations, the content management system 120 can include a set of determined content items that include more than just the content items that were selected to be initially displayed (“alternative content items”) or content for content items in addition to that which is initially displayed in the content items (“additional content”). In this way, the rule set can instruct the user device 106, as described above, to present these alternative content items and/or this additional content (e.g., resource links) in response to certain user interactions.

Adjusted predicted performance measures for the determined content items are received from the user device (210). In some implementations, the content management system 120 receives the adjusted predicted performance measures from the user device 106. For example, the rule set can include instructions that cause the user device 106 to send the adjusted predicted performance measures to the content management system 120 in response (e.g., only in response) to a user selection of one of the determined content items. Further, in some implementations, when the user device 106 sends the adjusted predicted performance measures to the content management system 120, the rule set includes instructions that cause the user device 106 to send only data specifying the adjusted predicted performance measures (e.g., and not send data specifying the user interactions that caused the adjustments to preserve the privacy of the user).

The predicted performance measures of the determined content items are updated based at least in part on the received adjusted predicted performance measures (212). In some implementations, the content management 120 accesses the predicted performance data store 124 and updates the predicted performance measures of the determined content items based on the adjusted predicted performance measures. For example, if the adjusted predicted performance measure for a particular determined content item is higher than the predicted performance measure for the determined content item stored in the predicted performance data store 124, the content management and delivery system 120 can increase the predicted performance measure for the determined content item stored in the predicted performance data store 124 by an amount proportional to the difference between the adjusted predicted performance measure and the stored (e.g., previous) predicted performance measure.

In some implementations, the content management system 120 can use the adjusted predicted performance measure for purposes beyond (or alternative to) updating the predicted performance measures for content items. For example, the content management and delivery system 120 can use the adjusted predicted performance measure to set or adjust the cost (e.g., the content sponsor's bid) charged by it to the content sponsor of a determined content item for a selection of the content sponsor's content item.

Continuing with the above example, in response to a content item request, a first content sponsor's first content item can be awarded the top display slot in a content item selection process over a second content item from a second content sponsor (that is awarded a lower or no slot). When a comparison of the adjusted predicted performance measures for the two content items indicate that the first content item is more likely to be selected, relative to the second content item, than initially expected based on the initial predicted performance measures (e.g., prior to being adjusted and as used in the selection process), the content management system 120 can reduce the first content sponsor's cost for a selection. For example, the reduction can be in an amount that is a function (e.g., proportional to the ratio) of the adjusted predicted performance measure of the first and second content items. In this example the cost can be reduced because there was less risk than initially expected to the content management system 120 and the publisher of the resource 105, on which the content items were presented, that the first content item would not be selected (and thus less risk that no revenue would be generated from the impression).

Likewise, if a comparison of the adjusted predicted performance measures for the two content items indicate that the first content item is less likely to be selected, relative to the second content item, than initially expected based on the initial predicted performance measures, the content management system 120 can increase the first content sponsor's cost for the selection. For example, the increase can be in an amount that is a function of the adjusted predicted performance measure of the first and second content items. In this example, the cost can be increased because there was more risk than initially expected to the content management system 120 and the publisher that the first content item would not be selected. Other cost adjustment schemes based on adjusted predicted performance measures can be also utilized.

In some implementations, the rule set causes the user device 106, in addition or alternative to providing the adjusted predicted performance measures to the content management system 120, to provide data indicating an effectiveness of one or more rules from the rule set. For example, as described above, the rule set can include rules that specify certain initial content item display treatments based on user preferences stored locally at the user device 106. One such rule, for example, for a content item advertising products for a home improvement store with a section to place links to various departments in the store, e.g., a home/garden department, a plumbing department and a lumber department, may specify how to select which particular departments will have a link based on the user preference data. If a user causes one of the links to be selected, the rule can cause data to be sent to the content management system 120 indicating that the rule was effective/successful, as a rule-specified link was selected. Conversely, if no links are selected, the rule can cause data to be sent to the content management system 120 indicating that the rule was not effective/successful. In some implementations, the only data provided to the content management system 120 in response to a user interaction (or otherwise caused by the rule set) is this effectiveness data.

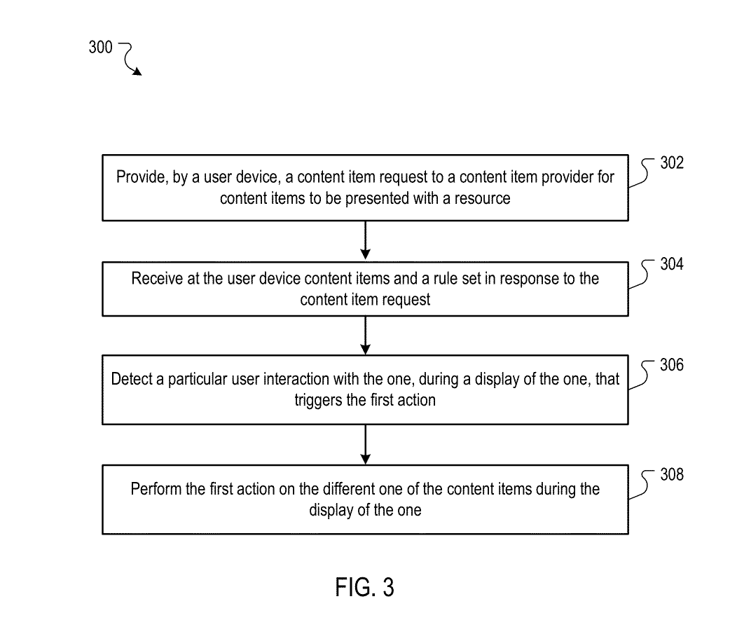

While the process 200 describes an exemplary rule set provision process from the content management and delivery system 120 perspective, the process 300 describes an exemplary rule set application process from the user device 106 perspective. FIG. 3 is a flow diagram of an example process 300 for performing actions according to the rule set.

A content item request is provided to a content item provider for content items to be presented with a resource (302). In some implementations, the user device 106 provides the content item request to the content management system 120 (e.g., a content item provider). For example, the user device 106 submits the content item request in response to accessing a resource 105 with instructions (e.g., an embedded script in the HTML of the resource 105) that cause the user device 106 to send the content item request.

Content items and a rule set are received in response to the content item request (304). In some implementations, the user device 106 receives, in response to the content item request, the content items and the rule set from the content management system 120.

In some implementations, the rule set specifies one or more pre-determined user device responses to particular user interactions with one or more of the content items. The pre-determined user device responses can include a first action of changing a display or parameter of a given content item (e.g., a content item other than the content item interacted with by a user). For example, the user interaction can be a user causing the user device 106 to hover a mouse cursor over a first content item. The pre-determined user device response to this user interaction, as specified in the rule set, can be, for example, to cause the user device 106 to replace a currently displayed content item (e.g., other than the first content item) with another content item, which is not currently displayed, that has subject matter more related to the first content item than the currently displayed content item. More generally, the user interactions and pre-determined user device responses specified by the rule set can be the same or similar to those described above with reference to the process 200.

A particular user interaction is detected, that triggers the first action (306). In some implementations, the user device 106 detects the particular user interaction (e.g., a mouse hovering over a first content item) that triggers the first action (e.g., changing the display of another content item) by the user device 106 as specified by the rule set. As described above, the rule set can cause the user device 106 to detect user interactions through use of the user device's browser application's APIs.

The first action is executed (308). In some implementations, the first action can be performed on or in association with the one content item or on or in association with a different one of the content items. In some implementations, the user device 106 performs the first action on a content item, other than the particular content item that was the subject of the user interaction, while the particular content item remains displayed during the first action. For example, a user causes a user interaction with a first content item and, in response, the user device 106 swaps the display slots of two other content items concurrently presented with the first content item or adjusts the two other content items' predicted performance measures, as specified by the rule set.

Although the process 300 has been described with respect to the user device responses causing changes to content items other than the one that is the subject of the user interaction, in some implementations, the user device responses can include responses that change or adjust the display or parameters of the subject content item (e.g., change the subject content item's predicted performance measure or display configuration).

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. A computer storage medium is not a propagated signal and does not include transitory signals. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

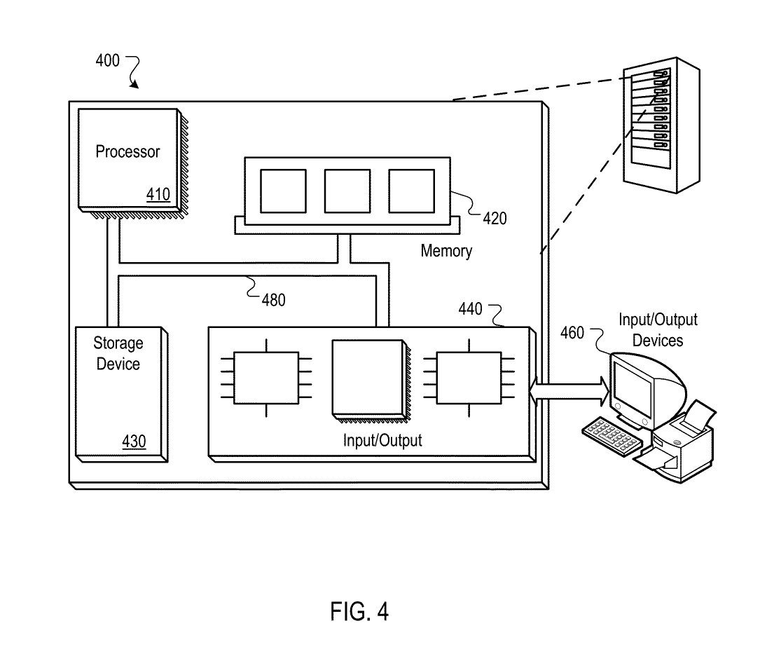

An example of one such type of computer is shown in FIG. 4, which shows a block diagram of a programmable processing system (system). The system 400 that can be utilized to implement the systems and methods described herein. The architecture of the system 400 can, for example, be used to implement a computer client, a computer server, or some other computer device.

The system 400 includes a processor 410, a memory 420, a storage device 430, and an input/output device 440. Each of the components 410, 420, 430, and 440 can, for example, be interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 300. In one implementation, the storage device 430 is a computer-readable medium. In various different implementations, the storage device 430 can, for example, include a hard disk device, an optical disk device, or some other large capacity storage device.

The input/output device 440 provides input/output operations for the system 400. In one implementation, the input/output device 440 can include one or more of a network interface device, e.g., an Ethernet card, a serial communication device, e.g., and RS-232 port, and/or a wireless interface device, e.g., an 802.11 card. In another implementation, the input/output device can include driver devices configured to receive input data and send output data to other input/output devices, e.g., keyboard, printer and display devices 460.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving a content item request from a user device for content items to be presented on the user device, the user device being associated with a user device identifier;
determining, by one or more data processors, content items responsive to the content item request, wherein each of the content items have a stored predicted performance measure;
identifying, by the one or more data processors and based at least in part on the user device identifier and a subject matter of the content item request, a rule set specifying adjustments to be performed, by the user device, to the predicted performance measures of the determined content items in response to particular user interactions with the determined content items when presented on the user device; and
providing, by the one or more data processors, in response to the content item request, and to the user device, a response that includes the determined content items, the stored predicted performance measures for the determined content items, and instructions that cause the user device to adjust, according to the rule set, the stored predicted performance measure of a first content item from the determined content items in response to user interaction with a second content item from the determined content items.

2. The method of claim 1, further comprising:
receiving, by the one or more data processors in response to user interaction with one of the determined content items, predicted performance measure adjustments for the determined content items from the user device; and
updating, by the one or more data processors, the stored predicted performance measures of the determined content items based at least in part on the predicted performance measure adjustments.

3. The method of claim 2, wherein receiving predicted performance measure adjustments comprises:
receiving the predicted performance measure adjustments in response to user selection of one of the determined content items, and wherein the predicted performance measure adjustments are received in response to the user selection of the one of the determined content items without data specifying the user selection.

4. The method of claim 2, further comprising:
adjusting costs, based at least in part on the predicted performance measure adjustments, to content sponsors of the determined content items for providing the determined content items to the user device in response to the content item request.

5. The method of claim 1, wherein the particular user interactions comprise at least one of user interactions resulting in cursor movements, font sizing, window sizing, or tabbing.

6. The method of claim 1, wherein a weight of at least one of the adjustments varies based on a level of a corresponding user interaction.

7. The method of claim 6, wherein the level of the corresponding user interaction is a measure of a duration of the corresponding user interaction.

8. The method of claim 1, wherein the adjustments comprise adjustments to one or more of pricing, layout, display treatments, or selection changes of the determined content items.

9. The method of claim 1, further comprising:
generating the rule set based at least in part on the user device identifier and a subject matter of the content item request.

10. The method of claim 1, further comprising:
in response to providing the instructions, receiving effectiveness data from the user device indicating an effectiveness of one or more rules from the rule set without receiving data specifying the user interaction with the second content item.

11. A method comprising:
receiving a content item request from a user device for content items to be presented on the user device, the user device being associated with a user device identifier;
determining, by one or more data processors, content items responsive to the content item request;
generating, based at least in part on the user device identifier and a subject matter of the content item request, a rule set specifying a first action of changing a display of a given content item from the determined content items during a display of the given content item and in response to user interaction with a different content item from the determined content items; and
providing, to the user device and in response to the content item request, the determined content items and instructions that cause the user device to change, according to the rule set, the display of the given content item in response to user interaction with the different content item.

12-13. (canceled)

14. The method of claim 11, wherein the rule set specifies a second action of replacing the different content item with a previously un-displayed content item from the determined content items in response to a user interaction with the given content item, such that after the replacement the different content item is not displayed with the given content item and the previously un-displayed determined content item is displayed with the given content item.

15. The method of claim 11, wherein the rule set specifies a third action of removing any displayed determined content items in response to a user not interacting with the determined content items within a specified amount of time.

16. The method of claim 11, wherein the rule set specifies a fourth action of adjusting a predicted performance measure for each of the determined content items that are in display slots below a display fold following user resizing of a display window.

17. The method of claim 11, wherein the rule set specifies a fifth action of applying display treatments to the given content item.

18. A method comprising:
providing, by a user device, a content item request to a content item provider for content items to be presented with a resource;
receiving, at the user device, content items and a rule set in response to the content item request, the rule set specifying one or more pre-determined user device responses to particular user interactions with a first content item from the content items, the one or more pre-determined user device responses including a first action of changing a display of a different content item from the content items in response to user interaction with the first content item;
detecting, during a display of the first content item and by the user device, a particular user interaction with the first content item that triggers the first action; and
performing, in response to detecting the particular user interaction and by the use device, the first action on the different content item to change a display of the different content item during the display of the first content item and a different content item.

19. The method of claim 18, wherein the particular user interactions comprise at least one of user interactions resulting in cursor movements, font sizing, window sizing, or tabbing.

20. A system comprising:
one or more data processors; and
instructions stored on a computer-readable storage apparatus that when executed by the one or more data processors cause the one or more data processors to perform operations comprising:
receiving a content item request from a user device for content items to be presented on the user device, the user device being associated with a user device identifier;
determining content items responsive to the content item request, wherein each of the content items have a stored predicted performance measure;
identifying, based at least in part on the user device identifier and a subject matter of the content item request, a rule set specifying adjustments to be performed by the user device to the predicted performance measures of the determined content items in response to particular user interactions with the determined content items when presented on the user device; and
providing, in response to the content item request and to the user device, a response that includes the determined content items, the stored predicted performance measures for the determined content items, and instructions that cause the user device to adjust, according to the rule set, the stored predicted performance measure of a first content item from the determined content items in response to user interaction with a second content item from the determined content items.
